(19) United States
(12) Patent Application Publication
(10) Pub. No.: US 2021/0379596 A1
(43) Pub. Date: Dec. 9, 2021

(54) VIAL HOLDER

(71) Applicant: Merck Sharp & Dohme Corp., Rahway, NJ (US)

(72) Inventors: Shane Owen Peechatka, Blue Bell, PA (US); Kristen Mancini, Hatfield, PA (US)

(73) Assignee: Merck Sharp & Dohme Corp., Rahway, NJ (US)

(21) Appl. No.: 17/336,435

(22) Filed: Jun. 2, 2021

Related U.S. Application Data
(60) Provisional application No. 63/035,010, filed on Jun. 5, 2020.

(51) Int. Cl. B01L 9/06

(52) U.S. Cl. CPC B01L 9/06; B33Y 80/00

(57) ABSTRACT

A vial holder for holding and stabilizing vials, the vial holder comprising a base, and both a vertical mount and a horizontal mount extending from one side of the base. The vertical mount comprises a cylindrical cavity configured to receive and rotatably attach the vial to the base such that the vial is held to the base in a generally vertical orientation, while the horizontal mount comprises a body support and a neck support configured to receive and rotatably attach the body and the neck of the vial to the base such that the vial is held to the base in a generally horizontal orientation. In both orientations, the vial holder of the present invention provides easy access to most of the exterior surfaces of the vials and reduces safety hazards associated with creating sample defects on vials for purposes of qualification testing for vial inspectors.

### FIELD OF ART

The present invention relates generally to holders, stands and clamps for pharmaceutical product containers, and more particularly to holders, stands and clamps for vials.

### RELATED ART

Pharmaceutical products, such as drugs and vaccines, are often stored, shipped and/or distributed in vials made from glass or plastic. To ensure that these vials are free of potentially serious defects, such as breaks, cracks, chips, cuts, dents, nicks, scrapes, or abrasions on the inside or outside surfaces of the vials when they reach consumers, and to ensure that the solutions inside the vials do not contain any dangerous or otherwise undesirable particulates, drug and vaccine manufacturers frequently employ skilled inspectors to inspect batches of drugs and vaccines, or to monitor drug and vaccine production lines, to identify and remove vials containing such defects.

The inspectors that are employed to identify and remove defective vials from drug and vaccine batches or production lines typically go through training, testing and qualification program designed to confirm that they have achieved (or maintained) a certain level of proficiency at doing the job. In certain cases, the training, testing and qualification programs involve intentionally creating defective vials, mixing those defective vials among non-defective vials in a larger batch or production line, and then determining through testing how well each inspector or inspector candidate performs the task of identifying and removing those defective vials from the batch or production line. Often, candidates who wish to be certified as inspectors, as well as previously qualified inspectors seeking to be re-certified, must identify and remove a certain number of defective vials from a batch or production line before they are certified (or re-certified) to carry out inspections (or continue carrying out inspections) on real, commercial batches or production lines for drugs or vaccines.

For testing purposes, testers alter non-defective vials to change them into damaged and defective vials with the help of a variety of handheld instruments and tools, such as, for example, knives, needles, nails, files, razor blades, spikes, etching devices or hacksaws. Testers also use a variety of handheld power tools, such as electric dremels, drills, rotary saws or augers, to create damaged and defective vials. Sometimes, testers create damaged and/or defective vials using heat- and flame-producing devices, such as soldering irons, cigarette lighters or handheld torches. Syringes with needles may be used to dent or puncture vials and/or introduce particulates into the solutions carried inside the vials. All of these handheld instruments and tools have the potential to cause serious injury to humans while they are being used to create a damaged or defective vial, especially if the vial is not held securely in a stabile position during the defect creation. While creating sample defects, testers frequently try to hold and manipulate the vial with one hand while holding and manipulating the defect-creating handheld instrument or tool in the other hand. Holding and manipulating the vial in one hand typically brings that hand into close proximity with the business ends of a variety of very sharp, very pointed, very cold and/or very hot tools. This creates a serious safety hazard for testers.

Prior art vial holders have proven to be unsuitable for holding vials securely and safely while performing tasks associated with creating sample defects for inspector qualification tests. For example, many prior vial holders are designed to hold a collection of multiple vials arranged in close proximity to each other and in a substantially uniform line or grid pattern to facilitate multiple pipetting, where the objective is to quickly add a solution to multiple vials simultaneously, or to quickly remove samples of a solution from multiple vials simultaneously, either by hand or by operation of a machine. The construction of such prior art vial holders does not permit easy access to most of the exterior surfaces of a single vial.

Prior to the development of the present invention, there was no vial-holding device available that could adequately hold the vials stable and securely in either a vertical or a horizontal position during defect creation so that testers would not need to use one of their hands to hold the vial steady while the instrument or tool being used to create the defect is in contact with the vial. There was also no vial-holding device suitably configured to permit 360-degree access to that portion of the vial currently being worked on to create a defect (i.e., easy access to the full circumference of the body of the vial).

Accordingly, there is still a need in the pharmaceutical and pharmaceutical packaging fields for a vial holder configured to hold and stabilize a vial in either a vertical or a horizontal position, while exposing and providing easy access to different portions of the vial.

### SUMMARY OF THE INVENTION

As will be described in more detail below, aspects and embodiments of the present invention address the above-described needs, as well as other deficiencies and problems associated with known vial-holding devices, by providing a vial holder for a vial comprising a base, a vertical mount and a horizontal mount. The base has a top side and a bottom side. Both of the vertical and horizontal mounts extend from the top side of the base. The vertical mount is configured to receive and rotatably secure the vial to the base in a generally vertical orientation (i.e., so that the major axis of the body of the vial lies in a plane that is more or less perpendicular to the plane of the top side of the base), while the horizontal mount is configured to receive and rotatably secure the vial to the base in a generally horizontal orientation (i.e., so that the major axis of the body of the vial lies in a plane that is more or less parallel to the plane of the top side of the base). In either orientation, or both of them, the vial holder of the present invention provides easy access to most of the exterior surfaces of the vials.

Typically, vials used for drugs and vaccines will have a top, a crown, a neck, a shoulder, a body, a heel and a bottom. Accordingly, embodiments of the vial holder of the present invention provide support for vials having these physical characteristics. For example, the vertical mount, which extends from the top side of the base, comprises a cylindrical wall defining a cylindrical cavity with an opening at one end, the cylindrical cavity and the opening being adapted to receive and hold (i) the heel and the bottom of the vial, and (ii) the top, crown, neck and shoulder of the vial. In other words, the cylindrical cavity of the vertical mount of the vial holder is advantageously configured (in terms of its geometry) so that it can receive and hold both the top end of vial and the bottom end of the vial, although not simultaneously. Thus, the same vertical mount can sometimes be used to hold the cap, neck and/or should of the vial, while at other times it can be used to hold the bottom and/or the heel of the vial. Whether the vertical mount is used to hold the top end of the vial or the bottom end of the vial will be up to the user, depending on which end of the vial the user wants to expose for purposes of creating defects. When the vertical mount of the vial holder is used to hold the heel and the bottom of the vial so that the vial is in an upright position, the top, crown, neck, shoulder and an upper portion of the body of the vial are exposed and generally unobstructed by the vertical mount, thereby permitting easy access to these portions of the vial to facilitate creating sample defects thereon. When the vial is turned upside down and the top end of the vail is inserted into the same vertical mount of the vial holder, potions of the bottom and the heel of the vial are exposed and generally unobstructed by the vertical mount, thereby permitting easy access to these portions of the vial so as to facilitate safer and more efficient creation of sample defects thereon.

In some embodiments, at least part of the cylindrical wall defining the cylindrical cavity extends upward from the top side of the base so that the opening in the cylindrical cavity lies in a plane located above the top side of the base. In other embodiments, at least part of the cylindrical wall defining the cylindrical cavity extends downward and below the top side of the base so that the opening in the cylindrical cavity is substantially coplanar with the top side of the base. In still other embodiments, at least one part of the cylindrical wall defining the cylindrical cavity extends above the top side of the base, and at least another part of the cylindrical wall defining the cylindrical cavity extends below the top side of the base. Embodiments also may (or may not) include a second opening in the cylindrical cavity, wherein the plane of the second opening coincides with the bottom side of the base. In embodiments where the second opening is present on the bottom side of the vial, the vial may be inserted into the vertical mount of the base by pushing the vial through the second opening on the bottom side.

The horizontal mount, which also extends from the top side of the base, is configured to receive and rotatably secure the vial to the base in a generally horizontal orientation (i.e., such that the central axis of the body of the vial lies in a plane that is roughly parallel to the plane of the top side of the base). In this orientation, both the top and the bottom of the vial, as well as portions of the crown, the neck, the shoulder, the body and the heel, are exposed and will remain generally unobstructed by the horizontal mount itself. The horizontal mount further comprises a body support for the vial and a neck support for the vial. The body support comprises a first inverted rounded arch defining a first rounded slot adapted to receive and support a section of the body of the vial, and the neck support comprises a second inverted rounded arch defining a second rounded slot adapted to receive and support a section of the neck of the vial.

Preferably, the body support and the neck support of the horizontal mount are separated from the plane of the top side of the base so that there is at least some degree of spacing (or clearance) underneath the vial, i.e., between the top side of the base and the downward facing portions of the vial, when the vial is resting on the body support and the neck support of the horizontal mount. This spacing promotes and facilitates easier access to a greater amount of the surface area of the vial with hand and power tools for creating defects, and also make it easier to rotate the vial while it is resting on the horizontal mount. To achieve the desired spacing, some embodiments of the vial holder suitably include a substantially rigid body support riser disposed between the first inverted rounded arch of the body support and the top side of base, as well as a substantially rigid neck support riser disposed between the second inverted rounded arch of the body support and the top side of base, thereby separating the first and second inverted rounded arches from the top side of the base.

Typically, it will be necessary or desirable to secure the vial holder of the present invention to a table or work bench so that the device will not move while it is being used to create defects in vials. Accordingly, some embodiments of the present invention further include one or more recesses (or “cut outs”) in at least one edge of the top side of the base, which define one or more niches, respectively, that are configured to receive and accept the jaws of one or more table clamps in such a way that the tops of the table clamp jaws do not rise significantly above the top side of the base while the table clamp is holding the base tight to the table. With this configuration, the tops of the table clamp jaws are much less likely to interfere with easy access to the vials currently being held and supported by the vertical or horizontal mounts on the vial holder.

Preferably, but not necessarily, the vertical and horizontal mounts are designed to hold the same vial (or at least vials of the same dimensions) in both of the available (vertical or horizontal) orientations. Accordingly, the diameter (D1) of the cylindrical cavity in the vertical mount may be equal in size to the diameter (D2) of the first inverted rounded arch of the body support of the horizontal mount. In other embodiments, however, the diameter (D1) of the cylindrical cavity in the vertical mount may be different from the diameter (D2) of the first inverted rounded arch of the body support. For example, the diameter (D2), or the radius, of the first inverted rounded arch in the horizontal support may be considerably smaller or considerably larger than the diameter (or radius) of the cylindrical cavity in the vertical mount without departing from the scope of the claimed invention.

In some embodiments, the cylindrical cavity in the vertical mount may have a diameter D1 that is slightly smaller than the diameter of the vial at the heel of the vial (or at the shoulder of the vial) so that the heel and the bottom of the vial (or the shoulder, neck and crown of the vial) may be removably “snap-fitted” into place in the cylindrical cavity so that the vial is more securely held in place in a vertical orientation. Similarly, the first rounded slot in the body support of the horizontal mount may have a diameter (D2) that is slightly smaller than the diameter of the body of the vial so that the body of the vial may be removably “snap-fitted” into the first rounded slot of the body support of the horizontal mount. The second rounded slot in the neck support of the horizontal mount may have a diameter (D3) that is slightly smaller than the diameter of the neck of the vial so that the neck of the vial may be removably snap-fitted into the second rounded slot of the neck support. As shown in the figures and described in more detail below, the first inverted rounded arch of the body support of the horizontal mount may be elongated to define an elongated trough configured to support the body of the vial when the vial is placed in said horizontal orientation on the horizontal mount.

Holding the vial in a generally vertical orientation means the vial may be held by the vial holder in any orientation in which the angle between the major axis of the vial and the plane of the top side of the base is greater than or equal to 45 degrees (and less than or equal to 135 degrees).

Holding the vial in a generally horizontal orientation means the vial may be held by the vial holder in any orientation in which the angle between the major axis of the vial and the plane of the top side of the base is less than or equal to 45 degrees (or greater than or equal to 135 degrees). Typically, however, the vial holder will be configured to hold the vial at an angle of 90 degrees relative to the plane of the top side of the base, or at an angle of 0 (zero) degrees relative to the plane of the top side of the base, or both 90 degrees and 0 (zero) degrees relative to the top side of the base, because these angles typically provide the greatest access to the most surface area of the vial being held without having to rotate the vial in the holder.

The vial holder of the present invention may be constructed by separately fabricating the component parts, such as the base, the vertical mount and the horizontal mount, and then joining the component parts together to form the completed vial holder. Alternatively, vial holders configured in accordance with embodiments of the present invention may be constructed from a single piece of construction material (unitary construction), such as by using a three-dimensional (3D) printer or by injection molding. For purposes of fabricating the vial holder of the present invention by 3D printing, the material used for the 3D printing of the vial holder may include, for example, polyamide thermoplastic (Nylon), polyetherimide (PEI) thermoplastic, polyether ether keytone (PEEK) thermoplastic, or Acrylonitrile Butadiene Styrene (ABS) thermoplastic. However, it will be recognized by those skilled in the art that one or more other materials may be suitably adapted and used to fabricate vial holders of the present invention.

### BRIEF DESCRIPTION OF THE DRAWINGS

The present invention and various aspects, features and advantages thereof are explained in detail below with reference to exemplary and therefore non-limiting embodiments, and with the aid of the drawings, which constitute a part of this specification and include depictions of the exemplary embodiments. In these drawings:

FIG. 1 shows a front and right perspective view of a vial holder according to one embodiment of the present invention.

FIGS. 2A, 2B, 2C and 2D show, respectively, a top view, a top and front perspective view, a top and left perspective view, and a top and right perspective view of the vial holder according to one embodiment of the present invention.

FIGS. 3A and 3B show, respectively, a top and rear perspective view, and a bottom view of the vial holder according to an embodiment of the present invention.

FIGS. 4A, 4B and 4C show, respectively, a front elevation view, a rear elevation view, and a right elevation view of the vial holder according to an embodiment of the present invention.

FIGS. 5A and 5B show, respectively, representative diagrams of an exemplary vial that could be held and stabilized by embodiments of the present invention. FIG. 5A shows the vial in a vertical orientation and FIG. 5B shows the vial in a horizontal orientation.

FIG. 6A shows a close-up view of the vertical mount as it would appear from above the vertical amount. FIG. 6B shows a cross sectional view of the vertical mount.

FIG. 7A shows a close-up view of the vertical mount as it would appear from above the vertical amount, wherein the vertical mount includes a second opening at the bottom end of the cylindrical cavity, and the plane of the second opening coincides with the plane of the bottom side of the base of the vial holder. FIG. 7B shows a cross sectional view of the vertical mount with the second opening at the bottom end of the cylindrical cavity.

FIGS. 8A, 8B and 8C show, respectively, a close-up view of the horizontal mount as viewed from above the horizontal mount, a cross-sectional view of the body support of the horizontal mount, and a cross-sectional view of the neck support of the horizontal mount.

FIGS. 9A and 9B show, respectively, a left and top perspective view and a rear, top and left perspective view of another embodiment of the present invention, wherein the locations of the vertical and horizontal mounts are swapped relative to the examples of the invention depicted in the previously-described figures.

### DETAILED DESCRIPTION OF EXEMPLARY EMBODIMENTS

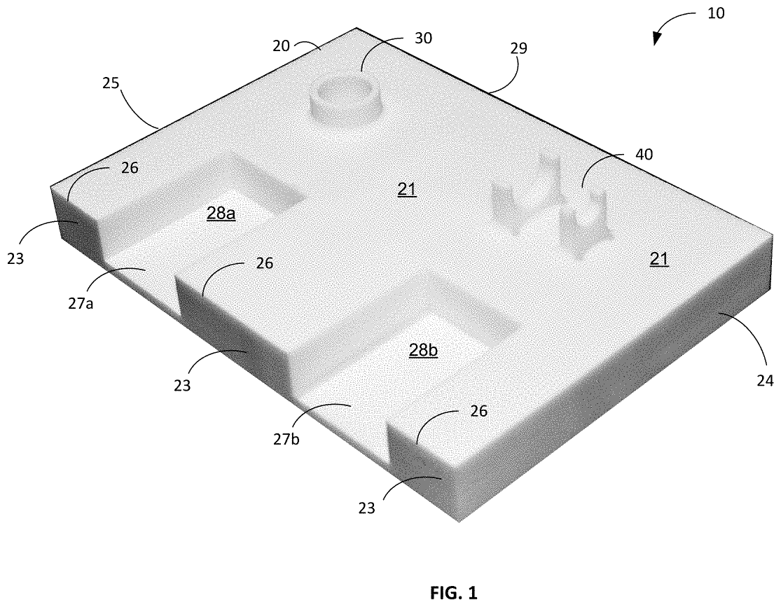

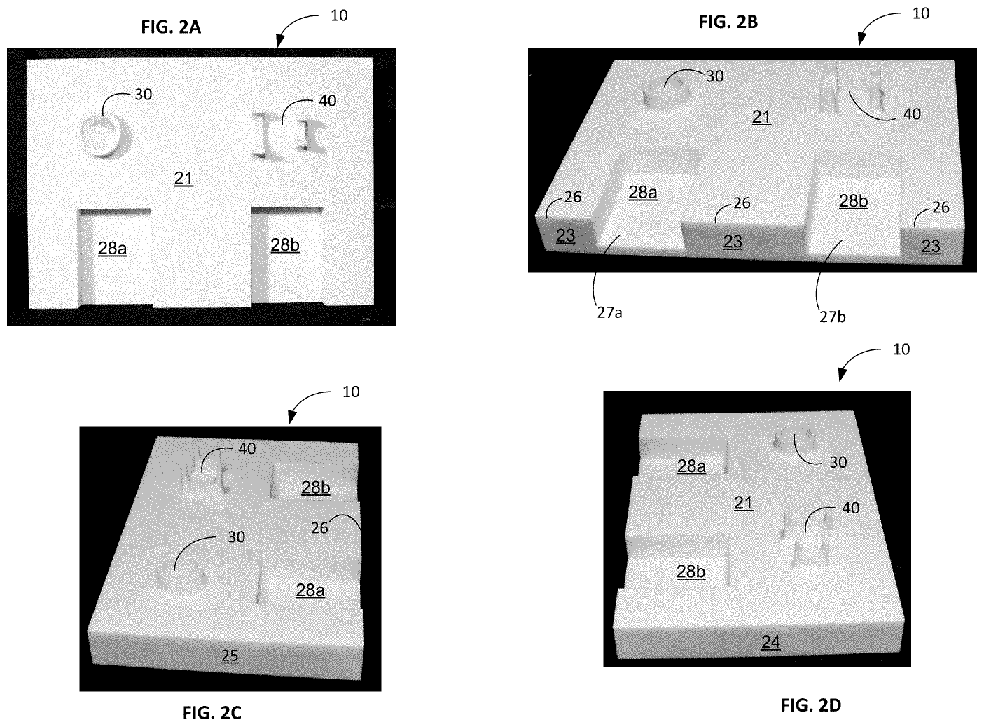

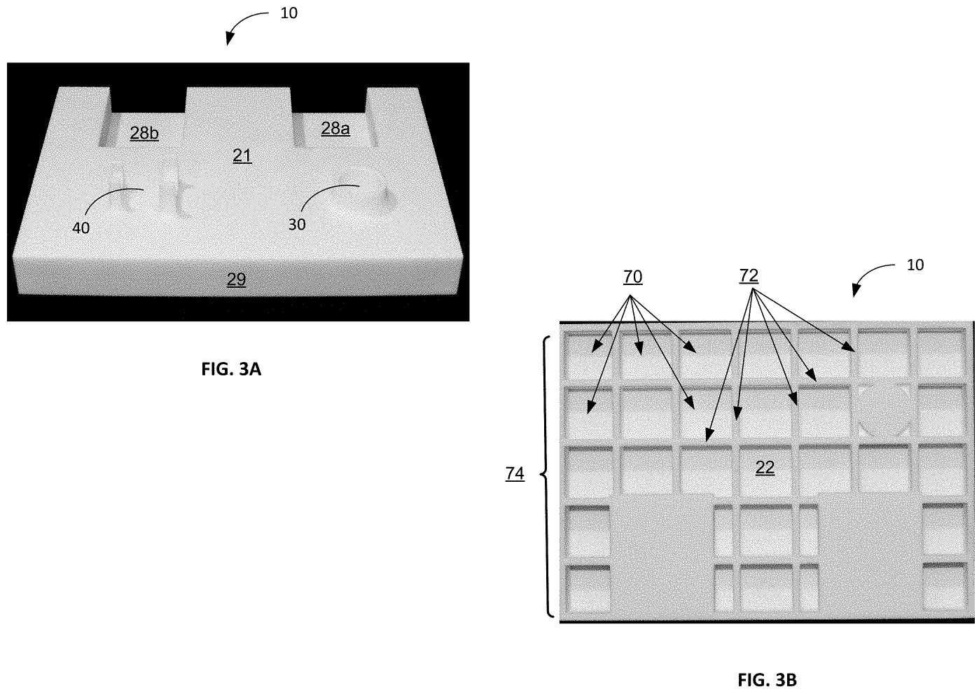

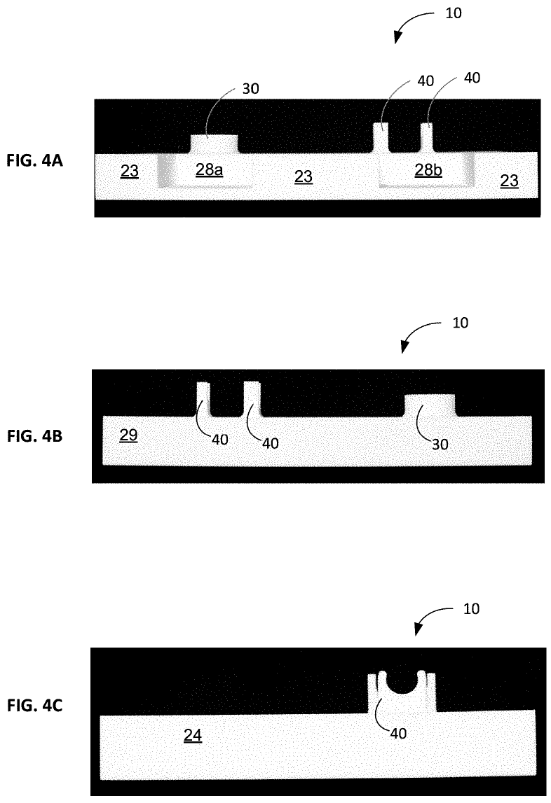

Exemplary vial holders according to embodiments of the present invention will now be described in more detail with reference to the figures. The vial holder of the present invention is generally designated as 10 in the accompanying figures. FIG. 1 shows a front and right perspective view of a vial holder 10 according to one embodiment of the present invention. FIGS. 2A, 2B, 2C and 2D show, respectively, a top view, a top and front perspective view, a top and left perspective view, and a top and right perspective view of the vial holder 10. FIGS. 3A shows a top and rear perspective view of the vial holder 10. FIG. 3B shows a bottom view of the vial holder 10. FIGS. 4A, 4B and 4C show, respectively, a front elevation view, a rear elevation view, and a right elevation view of the vial holder 10.

As illustrated in the figures, the vial holder 10 comprises a base 20 having a top side 21, a bottom side 22, a front side 23, a right side 24, a left side 25 and a rear side 29. The front side 23, right side 24, left side 25 and rear side 29 are configured to form generally vertical walls that are relatively perpendicular to the top side 21 and the bottom side 22 of the base 20. While the vial holder 10 depicted in the figures comprises a substantially rectangular solid that is substantially rectilinear in form, it will be recognized and appreciated by those skilled in the art that vial holders of the present invention may alternatively be constructed to form a variety of different geometrical shapes, including for example, a planar disk, triangle, pentagon, hexagon, octagon, or the like. In some embodiments, the surface of the bottom side 22 is substantially planar in shape (e.g., flat). In other embodiments, the surface of the bottom side 22 may comprise one or more voids or cutouts (or a multiplicity of voids or cutouts) to reduce the amount of material in the vial holder 10, and thereby reduce the weight of the vial holder 10. FIG. 3B shows such an embodiment, wherein the bottom side 22 comprises a multiplicity of rectangular cutouts 70 and intersecting walls 72 defining a grid-like pattern 74 on the surface of the bottom side 22. In still other embodiments, the top side 21 and/or the bottom side 22 of the base 20 may not be substantially planar or flat. For example, the top side 21 and/or the bottom side 22 of the base 20 could have a shape or geometry that is concave, convex, inclined, elliptical, reticulated, annular, beveled or grooved, depending, for example, on the shapes of the vials to be fastened to the holder or the tools and/or machines expected to be used with the vial holder 10 to create defects.

Cut into the edge 26 of the base 20, where the top side 21 and the front side 23 of the base 20 intersect, there is provided a pair of recesses 27a and 27b (or “cut outs”) defining a pair of niches 28a and 28b, respectively, which are configured to receive the jaws of a pair of clamps, such as a pair of table clamps or a pair of “c-clamps” (not shown in the figures), which can be used to fasten the base 20 of the vial holder 10 securely to a table or workbench (also not shown in the figures). Preferably, the niches 28a and 28b are sufficiently deep, relative to the jaws of the clamps and the plane of the top side 21 of the base 20, so that the jaws of the clamp do not extend above the plane of the top side 21 of the base 20, and thereby are able to fasten and hold the vial holder 10 securely to a desk, table or workbench without interfering with, or reducing easy access to the vial or vials mounted in the vertical mount 30 and/or the horizontal mount 40 of the vial holder 10, and do not pose a safety hazard due to the nearby operation and manipulation of hand or power tools being used to create sample defects in the vials.

The pair of recesses 27a and 27b, as well as the pair of niches 28a and 28b, also may be located on other edges of the base 20, such as the edge defining the intersection of the top side 21 and the rear side 29 of the base 20, the edge defining the intersection of the top side 21 and the right side 24 of the base 20, or the edge defining the intersection of the top side 21 and the left side 25 of the base 20. Depending on the size and shape of the vial holder 10, as well as the geometry of the table or workbench to which the vial holder 10 will be attached, the vial holder 10 may have only one recess, as well as three or more recesses, without departing from the scope of the claimed invention.

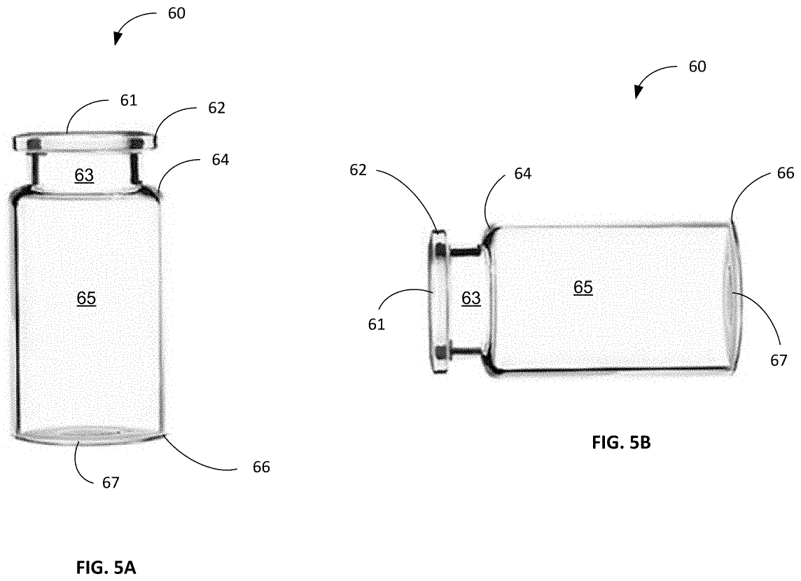

As stated above, the vial holder 10 of the present invention also includes a vertical mount (designated generally as 30) and a horizontal mount (designated generally as 40), both of which are configured to extend upward from the top side 21 of the base 20 of the vial holder 10. To simplify the discussion and improve the comprehension of the following detailed description of the geometries and the functions of the component parts of the vertical mount 30 and the horizontal mount 40, FIGS. 5A and 5B show diagrams of an exemplary vial 60. FIG. 5A shows the vial 60 in a vertical orientation (as the vial 60 would be oriented while it is attached to the vertical mount 30), and FIG. 5B shows the vial 60 in a horizontal orientation (as the vial 60 would be oriented while it is attached to the horizontal mount 40). As FIGS. 5A and 5B illustrate, the vial 60 has a top 61, a crown 62, a neck 63, a shoulder 64, a body 65, a heel 66 and a bottom 67. The top 61 may (or may not) be covered with a cap or plugged with a stopper (not shown in FIGS. 5A and 5B).

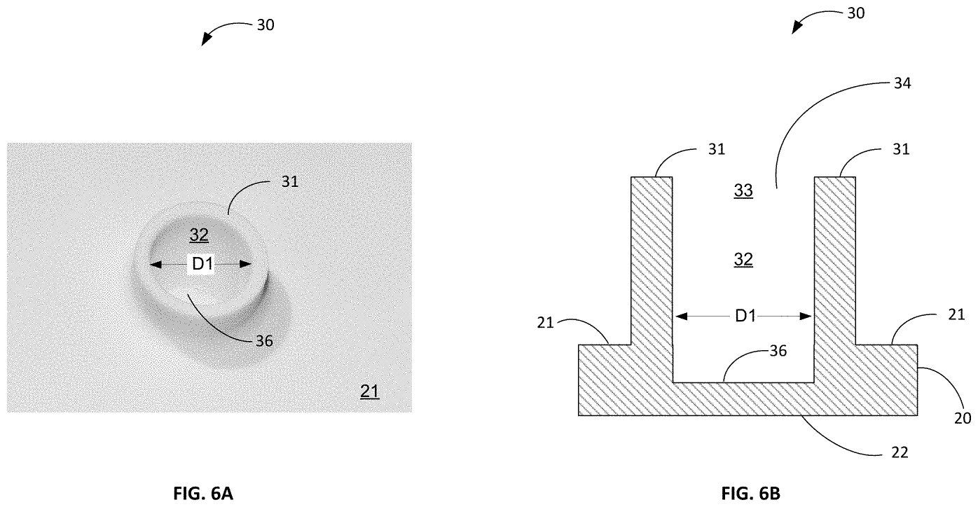

Turning now to the detailed descriptions of the vertical mount 30 of the vial holder 10, FIG. 6A shows a close-up view of the vertical mount 30 as it would appear if viewed from above the vertical mount 30. FIG. 6B shows a cross-sectional view of the vertical mount 30 as viewed from the front side 23 of the vial holder 10. As illustrated in FIGS. 6A and 6B, the vertical mount 30 comprises a cylindrical wall 31 defining a cylindrical cavity 32 with an opening 33 at the top end 34 of the cylindrical cavity 32. The cylindrical cavity 32 and the opening 33 at the top end 34 of the cylindrical cavity 32 are adapted to receive and rotatably hold the heel 66 and the bottom 67 of the vial 60. The cylindrical cavity 32 and the opening 33 at the top end 34 of the cylindrical cavity 32 may also be configured to receive and rotatably hold the top 61, crown 62, neck 63 and/or shoulder 64 of the vial 60.

When the vertical mount 30 of the vial holder 10 is used to hold the heel 66 and the bottom 67 of the vial 60 so that the vial 60 is in an upright position (as shown in FIG. 5A), the top 61, crown 62 , neck 63, shoulder 64 and an upper portion of the body 65 of the vial 60 are exposed and remain substantially unobstructed by the vertical mount 30. This enables easy access to these portions of the vial 60 to facilitate creating sample defects thereon. When the vertical mount 30 of the vial holder 10 is used to hold the top 61, crown 62, neck 63 and shoulder 64 of the vial 60 so that the vial 60 is inverted, the heel 66, the bottom 67 and a lower portion of body 65 of the vial 60 are exposed and substantially unobstructed by the vertical mount 30, which facilitates easy access to these portions of the vial 60 for the purpose of using hand or power tools to create sample defects thereon.

Preferably, the diameter D1 of the cylindrical cavity 32 of the vertical mount 30 is slightly smaller than the diameter of the vial 60 at the heel 66 of the vial 60 (or at the shoulder 64 of the vial 60) so that the heel 66 and the bottom 67 of the vial 60 (or the shoulder 64, neck 63 and crown 62 of the vial 60) may be rotatably and removably “snap-fitted” into place inside the cylindrical cavity 32. Snap-fitting of the vial 60 inside the cylindrical cavity 32 tends to result in the vial 60 being more securely held in place in a vertical orientation while the vial 60 is worked on to create sample defects.

In some embodiments, and as shown in the figures, at least part of the cylindrical wall 31 defining the cylindrical cavity 32 extends upward from the top side 21 of the base 20 so that the opening 33 in the cylindrical cavity 32 lies in a plane that is located above the plane of the top side 21 of the base 20. In such cases, the bottom end 36 of the cylindrical cavity 32 may (or may not) lie in the same plane as the top side 21 of the base 20. In other embodiments, and as shown best in FIG. 6B, at least one part of the cylindrical wall 31 defining the cylindrical cavity 32 extends above the plane of the top side 21 of the base 20, and at least another part of the cylindrical wall 31 defining the cylindrical cavity 32 extends below the plane of the top side 21 of the base 20, so that the top end 34 of the cylindrical cavity 32 lies in a plane above the plane of the top side 21 of the base 20 and the bottom end 36 of the cylindrical cavity 32 lies in a plane below the plane of the top side 21 of the base 20. In still other embodiments, the cylindrical wall 31 of the vertical mount 30 may only extend downward from the plane of the top side 21 of the base 20, so that the opening 33 at the top end 34 of the cylindrical cavity 32 will lie substantially in the same plane as the top side 21 of the base 20.

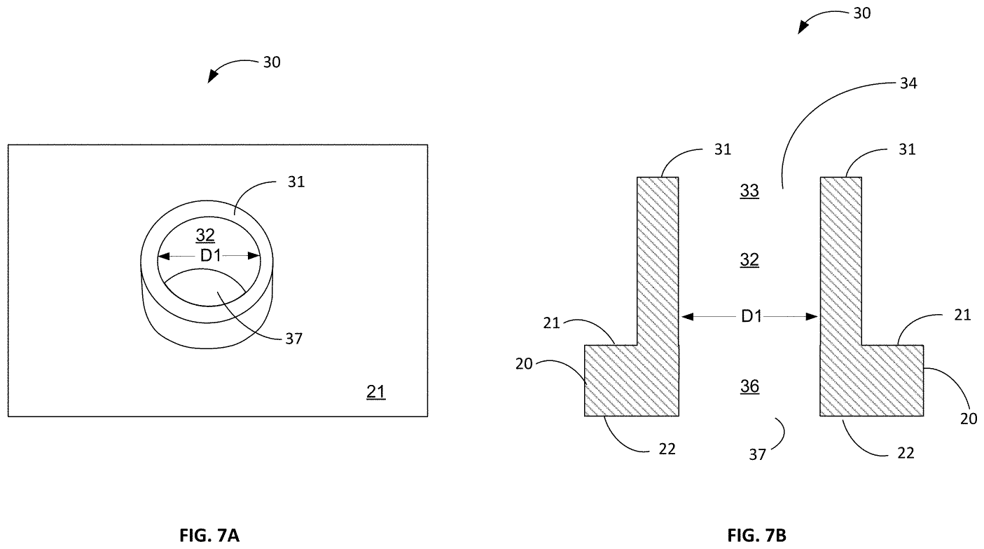

As shown in FIGS. 7A and 7B, some embodiments of the present invention may include a second opening 37 at the bottom end 36 of the cylindrical cavity 32, wherein the plane of the second opening coincides with the plane of the bottom side 22 of the base 20. In such embodiments, instead of inserting the vial 60 into the vertical mount 30 of the vial holder 10 from the top side 21 of the base 20, the vial 60 may be inserted into the vertical mount 30 of the vial holder 10 by pushing the vial 60 through the second opening on the bottom side 22 of the base 20. Suitably, the vial 60 may be inserted into the vial holder 10 by pushing the vial 60 (top, crown and neck-first) through the second opening 37 at the bottom end 36 of the cylindrical cavity 32 when an upright orientation of the vial 60 is desired while defect is created, or pushing the vial 60 (heel and bottom-first) through the second opening 37 at the bottom end 36 of the cylindrical cavity 32 when an inverted orientation of the vial 60 is desired during defect creation.

Typically, but not necessarily, the central axis of the cylindrical cavity 32 defined by the cylindrical wall 31 of the vertical mount 30 is normal to the plane of the top side 21 of the base 20. It is understood, however, that the central axis of the cylindrical cavity 32 defined by the cylindrical wall 31 of the vertical mount 30 does not necessarily have to be perpendicular to the plane of the top side 32 of the base 20. In some embodiments, for instance, the central axis of the cylindrical cavity 32 defined by the cylindrical wall 31 of the vertical mount 30 may lie at an angle that is anywhere between 45 degrees and 90 degrees relative to the plane of the top side 21 of the base 20, so that the major axis of the vial 60 held by the vertical mount 30 will also lie at the same angle relative to the plane of the top side 21 of the base 20.

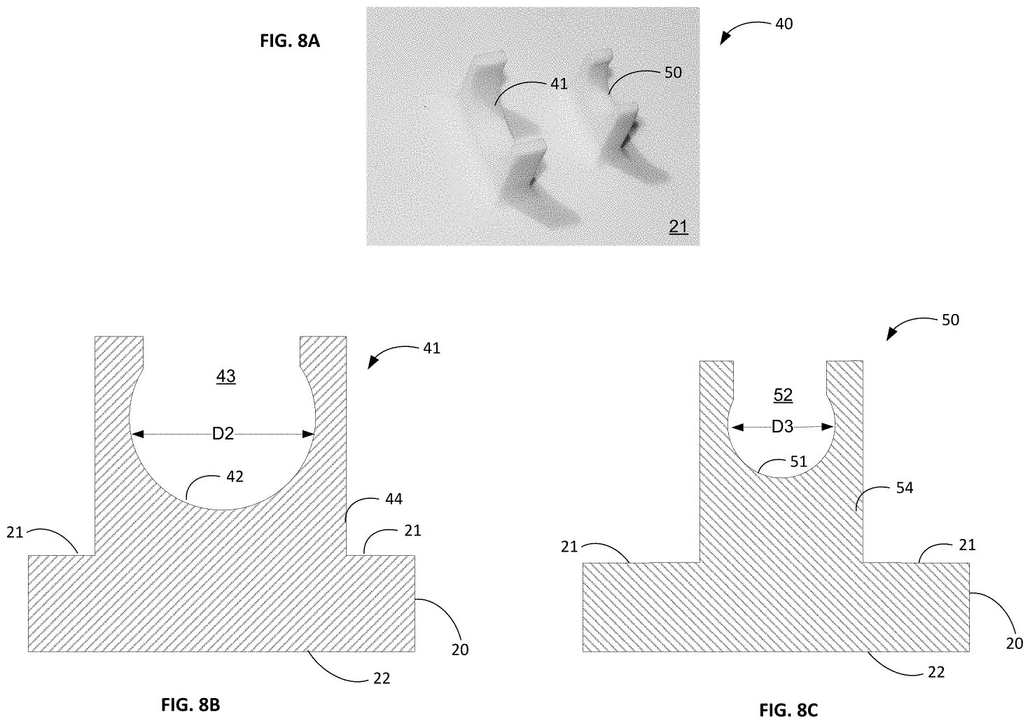

FIG. 8A shows a close-up view of the horizontal mount 40 as it would appear if viewed from above the horizontal mount 40. Like the vertical mount 30, the horizontal mount 40 also extends from the top side 21 of the base 20, and is configured to receive and rotatably secure the vial 60 to the base 20. However, the horizontal mount 40 secures the vial 60 in a generally horizontal orientation so that the top 61 and bottom 67 of the vial 60, as well as at least a portion of the crown 62, the neck 63, the shoulder 64, the body 65 and the heel 66, are exposed and substantially unobstructed by the horizontal mount 40 itself. As shown in FIG. 8A, the horizontal mount 40 includes two components extending from the top side 21 of the base 20; namely, a body support 41 to support the body 65 of the vial 60, and a neck support 50 to support the neck 63 of the vial 60. FIG. 8B shows a cross-sectional view of the body support 41, and FIG. 8C shows a cross-sectional view of the neck support 50 of the horizontal mount 40.

The body support 41 (shown best in FIG. 8B) of the horizontal mount 40 comprises a first inverted rounded arch 42 defining a first rounded slot 43 adapted to receive and support a section of the body 65 of the vial 60 while the vial 60 is attached to the body support 41 and the neck support 50 and lying in a generally horizontal orientation. The neck support 50 (shown best in FIG. 8C) comprises a second inverted rounded arch 51 defining a second rounded slot 52 adapted to receive and support a section of the neck 63 of the vial 60 while the vial 60 is attached to the body support 41 and the neck support 50 and lying in a generally horizontal orientation.

As illustrated by the examples of the body support 41 and the neck support 50 shown in FIGS. 8B and 8C, respectively, the body support 41 and the neck support 50 of the horizontal mount 40 may be separated and spaced apart from each other. The body support 41 and the neck support 50 of the horizontal mount 40 also may be separated from (i.e., lifted above) the plane of the top side 21 of the base 20 so that there exists at least some measure of spacing (or clearance) underneath the vial 60, i.e., between the top side 21 of the base 20 and the downward facing portions of the vial 60, whenever the vial 60 is resting on the body support 41 and the neck support 50 of the horizontal mount 40. This spacing promotes and facilitates easier access to a greater portion of the vial 60 with hand and/or power tools while creating defects, and also make it easier to rotate the vial 60 while it is resting on the horizontal mount 40. To achieve the desired spacing, the body support 41 of the horizontal mount 40 suitably includes a substantially rigid body support riser 44 disposed between the first inverted rounded arch 42 of the body support 41 and the top side 21 of base 20, thereby separating the first inverted rounded arch 42 from the top side 21 of the base 20. Similarly, the neck support 50 of the horizontal mount 40 includes a substantially rigid neck support riser 54 disposed between the second inverted rounded arch 51 of the neck support 50 and the top side 21 of base 20, thereby separating the second inverted rounded arch 51 from the top side 21 of the base 20.

Normally, although not necessarily, the diameter D2 of the first rounded slot 43 of the body support 41 is substantially equal in size to the diameter D1 of the cylindrical cavity 32 of the vertical mount 30 so that the vertical mount 30 and the horizontal mount 40 will easily be able to accommodate moving vials from the vertical mount 30 to the horizontal mount 40, and vice versa. However, in some embodiments, depending on the geometry of the particular vial to be held, the diameter D2 of the first rounded slot 43 of the body support 41 may be substantially different in size compared to the diameter D1 of the cylindrical cavity 32 of the vertical mount 30. Preferably, the diameter D2 of the body support 41 of the horizontal mount 40 is slightly smaller in size than the diameter of the body 65 of the vial 60 so that the body 65 of the vial 60 may be removably snapped into the first rounded slot 43 defined by the first inverted rounded arch 42 of the body support 41. Likewise, the diameter D3 of the second rounded slot 52 of the neck support 50 of the horizontal mount 40 is preferably slightly smaller in size than the diameter of the neck 63 of the vial 60, so that the neck 63 of the vial 60 can be removably snapped into place in the second rounded slot 52 of the neck support 50.

Typically, but not necessarily, the central axes of the first rounded slot 43 and the second rounded slot 52 of the body support 41 of the horizontal mount 40 are parallel to the plane of the top side 21 of the base 20. It is understood, however, that the central axes of the first rounded slot 43 and the second rounded slot 52 of the body support 41 of the horizontal mount 40 do not necessarily have to be exactly parallel to the plane of the top side 21 of the base 20. In some embodiments, for instance, the central axes of the first rounded slot 43 and the second rounded slot 52 of the body support 41 of the horizontal mount 40 may lie at an angle that is anywhere between 0 degrees and 45 degrees relative to the plane of the top side 21 of the base 20, so that the major axis of the vial 60 held by the horizontal mount 40 will also lie at the same angle relative to the plane of the top side 21 of the base 20.

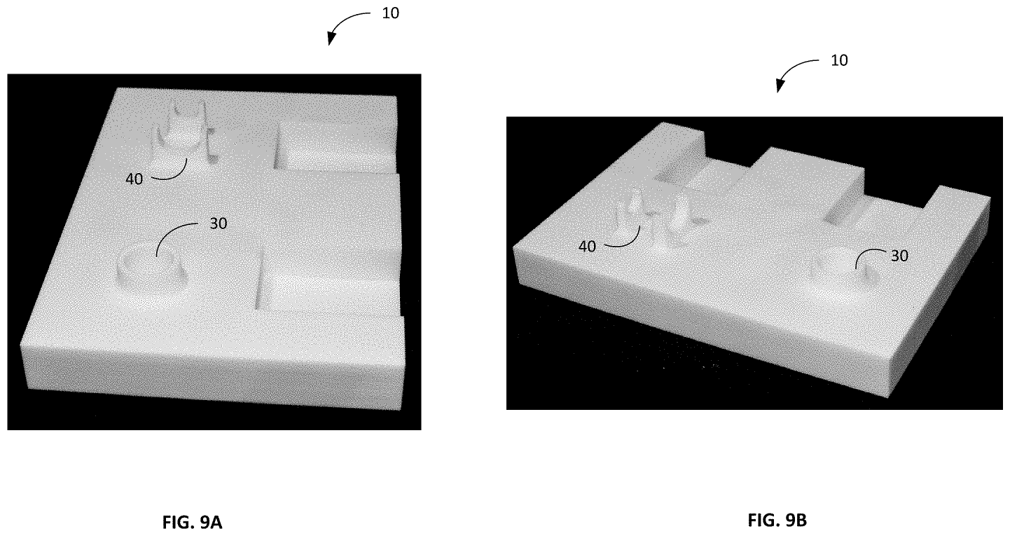

FIGS. 9A and 9B show, respectively, a left-side and top perspective view and a rear, top and left-side perspective view of a vial holder 10 according to yet another embodiment of the present invention, wherein the locations of the vertical mount 30 and the horizontal mount 40 are swapped relative to the examples of the invention depicted in the previously-described figures. It is understood that certain embodiments of the present invention may comprise a plurality of vertical and horizontal mounts so as to permit the vial holder 10 to hold a plurality of vials simultaneously.

It is anticipated that embodiments of the invention may be utilized in a variety of fields, including without limitation the fields of manufacturing, storing and distributing pharmaceuticals and containers for pharmaceuticals. Thus, embodiments of the present invention may be used to hold and stabilize vials while creating sample defects for inspector qualification testing. Under these circumstances, it may be necessary or desirable to construct the vial holder 10 from a single piece of material (unitary construction) that is easy to clean and/or sanitize, non-flammable, non-combustible, rust-proof, and able to withstand hot, cold and/or wet environments with little or no damage. Accordingly, employing a three-dimensional (3D) printer or an injection molding device to manufacture vial holders configured in accordance with embodiments of the present invention may be a cost-effective and beneficial approach. For purposes of fabricating the vial holder of the present invention by 3D printing, the material used for the 3D printing of the vial holder may include, for example, polyamide thermoplastic (Nylon), polyetherimide (PEI) thermoplastic, polyether ether keytone (PEEK) thermoplastic, or Acrylonitrile Butadiene Styrene (ABS) thermoplastic.

Although the exemplary embodiments, uses and advantages of the invention have been disclosed above with a certain degree of particularity, it will be apparent to those skilled in the art upon consideration of this specification and practice of the invention as disclosed herein that alterations and modifications can be made without departing from the spirit or the scope of the invention, which are intended to be limited only by the following claims and equivalents thereof

What is claimed is:

1. A vial holder for a vial, the vial having a top, a crown, a neck, a shoulder, a body, a heel and a bottom, the vial holder comprising:
a) a base having a top side and a bottom side;
b) a vertical mount, disposed on the top side of the base, adapted to receive and rotatably attach the vial to the base in a generally vertical orientation, the vertical mount comprising a cylindrical wall defining a cylindrical cavity with an opening at one end, the cylindrical cavity and the opening being adapted to receive and hold (i) the heel and the bottom of the vial so that the top, the crown, the neck, the shoulder and an upper portion of the body of the vial are exposed and substantially unobstructed by the vertical mount, and (ii) the top, the crown, the neck and the shoulder of the vial so that the bottom, the heel and a lower portion of body of the vial are exposed and unobstructed by the vertical mount;
c) a horizontal mount, disposed on the top side of the base, adapted to receive and rotatably attach the vial to the base in a generally horizontal orientation so that the top of the vial and the bottom of the vial, as well as a portion of the crown, the neck, the shoulder, the body and the heel, are exposed and unobstructed by the horizontal mount; and
d) the horizontal mount comprising a body support for the vial and a neck support for the vial, the body support comprising a first inverted rounded arch defining a first rounded slot adapted to receive and hold a section of the body of the vial, and the neck support comprising a second inverted rounded arch defining a second rounded slot adapted to receive and hold a section of the neck of the vial.

2. The vial holder of claim 1, wherein:
a) at least part of the cylindrical wall defining the cylindrical cavity extends from the top side of the base; and
b) the opening in the cylindrical cavity lies in a plane located above the top side of the base.

3. The vial holder of claim 1, wherein:
a) at least part of the cylindrical wall defining the cylindrical cavity extends below the top side of the base; and
b) the opening in the cylindrical cavity is substantially coplanar with the top side of the base.

4. The vial holder of claim 1, wherein:
a) at least one part of the cylindrical wall defining the cylindrical cavity extends above the top side of the base; and
b) at least another part of the cylindrical wall defining the cylindrical cavity extends below the top side of the base.

5. The vial holder of claim 4, further comprising a second opening in the cylindrical cavity, wherein the second opening is substantially coplanar with the bottom side of the base.

6. The vial holder of claim 1, further comprising:
a) a substantially rigid body support riser disposed between the first inverted rounded arch of the body support and the top side of the base; and
b) a substantially rigid neck support riser disposed between the second inverted rounded arch of the neck support and the top side of the base.

7. The vial holder of claim 1, further comprising a recess in at least one edge of the top side of the base, the recess defining a niche configured to receive a jaw of a table clamp.

8. The vial holder of claim 1, further comprising a second recess in the top side of the base, the second recess defining a second niche configured to receive a second jaw of a second table clamp.

9. The vial holder of claim 1, wherein:
a) the cylindrical cavity in the vertical mount has a diameter of D1;
b) the first rounded slot in the body support has a diameter of D2; and
c) the diameter D1 of the cylindrical cavity of the vertical mount is equal in size to the diameter D2 of the first inverted rounded arch of the body support of the horizontal mount.

10. The vial holder of claim 1, wherein the cylindrical cavity in the vertical mount has a diameter D1 that is slightly smaller than a diameter of the vial at the heel so that the heel and the bottom of the vial may be removably snap-fitted into the cylindrical cavity.

11. The vial holder of claim 1, wherein the cylindrical cavity in the vertical mount has a diameter D1 that is slightly smaller than a diameter of the vial at the shoulder so that the shoulder, neck and crown of the vial may be removably snap-fitted into the cylindrical cavity.

12. The vial holder of claim 1, wherein the first rounded slot in the body support of the horizontal mount has a diameter D2 that is slightly smaller than a diameter of the body of the vial so that the body of the vial may be removably snap-fitted into the first rounded slot of the body support.

13. The vial holder of claim 1, wherein the second rounded slot in the neck support of the horizontal mount has a diameter D3 that is slightly smaller than a diameter of the neck of the vial so that the neck of the vial may be removably snap-fitted into the second rounded slot of the neck support.

14. The vial holder of claim 1, wherein the first inverted rounded arch of the body support of the horizontal mount is elongated to define an elongated trough configured to support the body of the vial when the vial is placed in said generally horizontal orientation on the horizontal mount.

15. The vial holder of claim 1, wherein the base, the vertical mount and the horizontal mount are of unitary construction.

16. The vial holder of claim 15, wherein the unitary construction comprising the base, the vertical mount and the horizontal mount is fabricated by injection molding.

17. The vial holder of claim 15, wherein the unitary construction comprising the base, the vertical mount and the horizontal mount is fabricated by a three-dimensional (3D) printer.

18. The vial holder of claim 15, wherein the unitary construction comprising the base, the vertical mount and the horizontal mount is fabricated from one of:
a) polyamide thermoplastic (Nylon); or
b) polyetherimide (PEI) thermoplastic; or
c) polyether ether keytone (PEEK) thermoplastic; or
d) Acrylonitrile Butadiene Styrene (ABS) thermoplastic.

19. The vial holder of claim 1, wherein the top side of the base is substantially planar in shape.

20. The vial holder of claim 1, wherein the bottom side of the base is substantially planar in shape.
